(19) United States
(12) Patent Application Publication
(10) Pub. No.: US 2022/0364746 A1
(43) Pub. Date: Nov. 17, 2022

(54) Mist Maker Featuring Forced Airflow To Reduce Moisture Condensation And/Or Featuring Airflow Drifting

(71) Applicant: Zenu Design Co., Ltd., New Taipei (TW)

(72) Inventor: Yu-Hao Chou, New Taipei (TW)

(21) Appl. No.: 17/722,207

(22) Filed: Apr. 15, 2022

(30) Foreign Application Priority Data
May 13, 2021 (TW) 110117255

(51) Int. Cl. F24F 6/14; F24F 13/20; F24F 13/08; B05B 1/02

(52) U.S. Cl. CPC F24F 6/14; F24F 13/20; F24F 13/08; B05B 1/02; F24F 2006/146

(57) ABSTRACT

Disclosed is a mist maker featuring forced airflow to reduce moisture condensation and/or featuring airflow drifting, including: a hollow water-proof housing, a base, a atomizer, and an air blowing device, the base being disposed at the hollow water-proof housing, an accommodation space for accommodating an essential oil water solution, the atomizer being configured to atomize the essential oil water solution to form a mist; the air blowing device produces a forced airflow to push the mist; in further conjunction with a miniaturized landscape zone, a special profile is created; the forced airflow produced by the air blowing device is discharged radially via the air vents in the hollow water-proof housing, thereby carrying the mist overflowing out of the flow zone farther away to avoid mist accumulation around the mist maker and thus avoids water accumulation caused by mist condensation.

### FIELD

The disclosure relates to mist makers, and more particularly relates to a mist maker featuring forced airflow to reduce moisture condensation and/or featuring airflow drifting, which enables mist to drift within a preset flow zone to create a special visual effect, and/or reduces condensation of the mist overflowing out of the flow zone with a forced airflow to avoid formation of water stain on a worktop.

### BACKGROUND

Conventional mist makers come in a variety of types. One type is humidifiers, serving for indoor humidity control. A more sophisticated humidifier is equipped with a humidity sensing element and in the case that the room is overly dry, adds moisture to the air to restore indoor humidity to a comfortable level. A simpler humidifier only provides a mist outlet nozzle for example on top, with the mist being jetted upward, wherein the high-moisture air or the mist, when being evaporated from fine droplets and entering the air, will absorb partial heat in the air, rendering a cooler feeling to people.

Aroma diffuser is another type of mist maker, serving to add spice to the life. This type of mist makers usually has an ultrasonic oscillator. A user may drop essential oil on the water surface, such that the ultrasonic oscillator soaked in the water vibrates and atomizes the essential oil and the water together, wherein tiny droplets of perfumed water are pushed out upwardly via a mist outlet nozzle projecting from the mist maker, whereby to achieve the effects of air humidification and aroma dispersion. The water moisture that can be held in the air is certain under given atmospheric pressure and temperature. From the perspective of science, the maximum amount of water vapor that can be held in the air is defined as saturation humidity or 100% relative humidity, while the humidity level at any given time in a space is measured relative to the 100% saturation humidity. Once the humidity in the air approaches saturation, the excess vapor water will be changed into liquid water. For example, in the evening when air cools down, its capacity to hold water vapor decreases, such that the originally unsaturated air becomes saturated, and the excess water vapor will be condensed on the exterior of buildings, rocks, and leaves of plants. This phenomenon is generally referred to as getting damp. The frequently damped articles easily get moldy, mossy, rotten (in cases of wood articles), and rusty (in cases of metal).

Although the two types of mist makers differ somewhat from each other in functionality, the mist generation mechanisms they apply are the same. The jetted mist is substantially fine water droplets. After the mist is jetted upward via a mist outlet nozzle on top, the air humidity around the mist outlet nozzle becomes oversaturated and fails to be evaporated smoothly and completely, and the excess amount of the mist will be condensed into liquid water and fall slowly on the desk top or ground around the mist maker due to gravity, damping the desk top or the ground, which will not only cause water stains on the desk top, but also cause damages to the desk top, the books and stationary thereon, as well as the furniture nearby; in worse cases, the wetted ground nearby will cause accidents such as slip.

In addition, the mist outlet nozzle of conventional mist makers generally faces upward, such that the produced mist flows and diffuses upward, resembling a monotonous smoking chimney. However, it is always a desire for a user of the mist maker to create a comfortable and relaxing indoor atmosphere, while the monotonous mist emission pattern compromises the overall setting. Particularly, after the mist is condensed on the desktop due to poor diffusion of water vaper and overly high humidity around the mist maker, the contact area between the mist and the air significantly decreases, which reduces the amount of essential oil volatized to the air within a unit time and delays the time of dispersing the essential oil molecules to the entire indoor environment, thereby slowing down the time of aroma diffusion to reach a preset concentration level in the entire indoor environment. This is substantially a waste of the served essential oil; besides, it takes a long time to render a desired aromatic atmosphere.

### SUMMARY

A mist maker featuring forced airflow to reduce moisture condensation is provided, which leverages forced airflow to forcibly disperse high-moisture air or draw the high-moisture air back into the mist maker, so as to avoid moisture condensation around the mist maker due to moisture oversaturation.

A mist maker featuring forced airflow to reduce moisture condensation is provided, which enables dispersion of the mist towards all directions distant from the mist maker, such that essential oil in the mist may be quickly volatized and diffused to the entire indoor environment, thereby achieving rapid aroma diffusion.

A mist maker featuring airflow drifting is provided, which leverages a flow zone enclosed by a surrounding wall edge, a tilted mist outlet nozzle, and a miniaturized landscape zone having at least one tilted side, the direction of the mist outlet nozzle facing the miniaturized landscape zone, to enable the mist to drift in the flow zone to create a mist-enveloped scene, thereby solving the problem of overly monotonous mist pattern of conventional mist makers.

In an aspect of the disclosure, a mist maker featuring forced airflow to reduce moisture condensation comprises: a hollow water-proof housing, a base, an atomizer, and an air blowing device, wherein the hollow water-proof housing is formed with an accommodation space and has a pedestal, the pedestal being disposed on a worktop, an opening being provided on top of the accommodation space, the accommodation space being configured for accommodating liquid. The base at least partially covers the opening, and the hollow water-proof housing and/or the base are formed with a shaped portion whose projection direction corresponds to the opening, the shaped portion comprising a surrounding wall edge and a flow zone enclosed by the surrounding wall edge; wherein the hollow water-proof housing and/or the base are formed with at least one mist outlet nozzle corresponding to the flow zone. The atomizer is disposed in the hollow water-proof housing and/or the base, configured to atomize the liquid accommodated in the accommodation space and push the atomized liquid out via the mist outlet nozzle. The air blowing device is disposed at the hollow water-proof housing and/or the base to produce a forced airflow, the forced airflow flowing radially above the worktop but below the surrounding edge wall.

Since the forced airflow flows radially above but below the surrounding wall edge, the mist may be pushed radially distant from the mist maker; in this way, even the air around the mist maker has built up to a saturation humidity or an oversaturated state, its relative humidity is still lowered due to airflow dispersion, thereby preventing condensation of water droplets around the mist maker on the desktop or the ground from damaging the furniture or the surroundings; of course, the forced airflow may also be a high-moisture airflow drawn back to the humidifier so as to confine the overflow extent and avoid over-moisture of the external environment. In addition, the mist from the mist maker featuring forced airflow to reduce moisture condensation according to the disclosure does not condense on the desktop or the ground; instead, it may maintain the misty state or be absorbed by air, such that the mist has a relatively large contact area with the air; in this way, the essential oil ingredient in the mist may be extensively and quickly volatized to the air and dispersed to the entire indoor environment, rapidly rendering a preset aromatic smell to the user. Conventional humidifiers do not have an air blowing device, such that even in a relatively dry environment, the mist flowing out of such humidifiers is still accumulated around the humidifier, causing water accumulation. The mist maker featuring forced airflow to reduce moisture condensation according to the disclosure leverages the forced airflow to carry the mist radially away from the humidifier or draw the mist back to the humidifier in all directions, thereby avoiding water accumulation arising from the over-moisture air around the humidifier.

In a further aspect of the disclosure, a mist maker featuring airflow drifting comprises: a hollow water-proof housing, a base, an atomizer, and an air blowing device. The hollow water-proof housing is formed with an accommodation space and has a pedestal, the pedestal being disposed on a worktop, an opening being formed on top of the accommodation space, wherein the accommodation space is configured to accommodate liquid. The base is configured to at least partially cover the opening, the hollow water-proof housing and/or the base being provided with a shaped portion whose projection direction corresponds to the opening, the shaped portion comprising a surrounding wall edge, a flow zone enclosed by the surrounding wall edge, and a miniaturized landscape zone having at least one tilted face; wherein the hollow water-proof housing and/or the base are formed with at least one mist outlet nozzle corresponding to the flow zone, wherein the at least one mist outlet nozzle is tilted and faces the miniaturized landscape zone. The atomizer is disposed in the hollow water-proof housing and/or the base, configured to atomize the liquid accommodated in the accommodation space and push the atomized mist out via the at least one mist outlet nozzle. The air blowing device is disposed at the hollow water-proof housing and/or the base, configured to form a forced airflow.

Furthermore, a special visual effect may be created in conjunction with the miniaturized landscape design of the mist maker when the mist drifts in the flow zone defined by the mist maker structure, which also renders a relaxing and pleasing atmosphere desirable to the user. Additionally, the mist maker according to the disclosure enables both of reduced moisture condensation and mist drifting, such that even when producing an aromatic mist in a moisture indoor environment, the mist maker can still avoid water accumulation using the forced airflow, as well as creating a mist drifting visual effect. Therefore, besides the capability of atomizing perfumed water and diffusing the essential oil carried by mist droplets to the indoor environment like conventional technologies, the mist maker featuring forced airflow to reduce moisture condensation and/or featuring airflow drifting according to the disclosure further resolves the drawbacks of conventional mist makers such as monotonous mist pattern and proneness to water accumulation on a desktop or the ground.

### BRIEF DESCRIPTION OF THE DRAWINGS

FIG. 1 a stereoscopic view of a mist maker in an embodiment of the disclosure.

FIG. 2 is a top view of a mist maker featuring forced airflow to reduce moisture condensation and/or featuring airflow drifting of FIG. 1.

FIG. 3 is a front view of a mist maker featuring forced airflow to reduce moisture condensation and/or featuring airflow drifting of FIG. 1.

FIG. 4 is a right view of a mist maker featuring forced airflow to reduce moisture condensation and/or featuring airflow drifting of FIG. 1.

FIG. 5 is a bottom view of a mist maker featuring forced airflow to reduce moisture condensation and/or featuring airflow drifting of FIG. 1.

FIG. 6 is a left view of a mist maker featuring forced airflow to reduce moisture condensation and/or featuring airflow drifting of FIG. 1.

FIG. 7 is the sectional view along line A-A of FIG. 2.

FIG. 8 is the sectional view of the FIG. 2 along line B-B.

FIG. 9 is a top view of a mist maker according to another embodiment of the disclosure.

FIG. 10 is a top view of a mist maker according to an even further embodiment of the disclosure.

FIG. 11 is a top view of a mist maker according to still another embodiment of the disclosure.

FIG. 12 is a top view of a mist maker according to even still another embodiment of the disclosure.

FIG. 13 is a top view of a mist maker according to still yet another embodiment of the disclosure.

### DETAILED DESCRIPTION

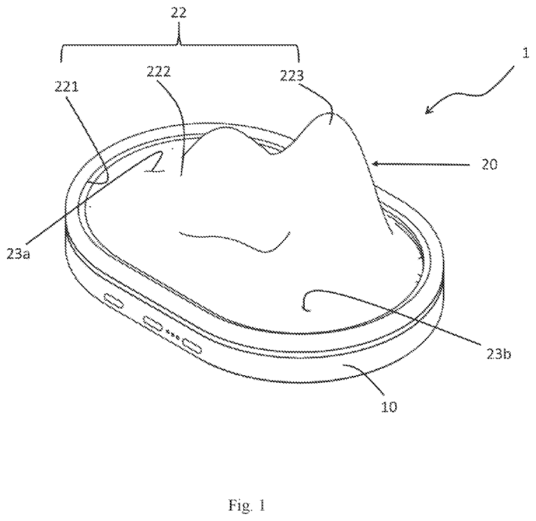

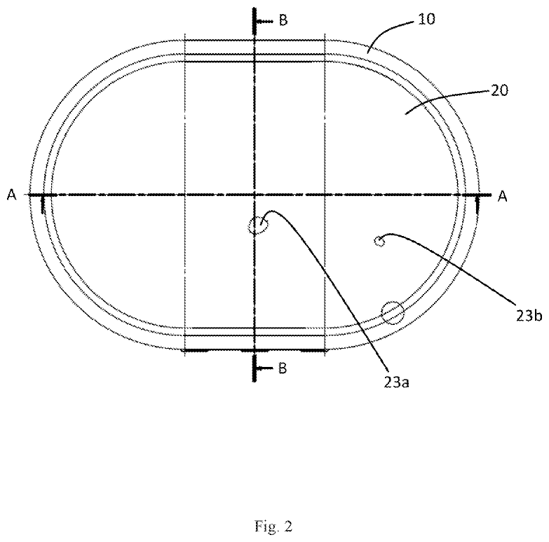

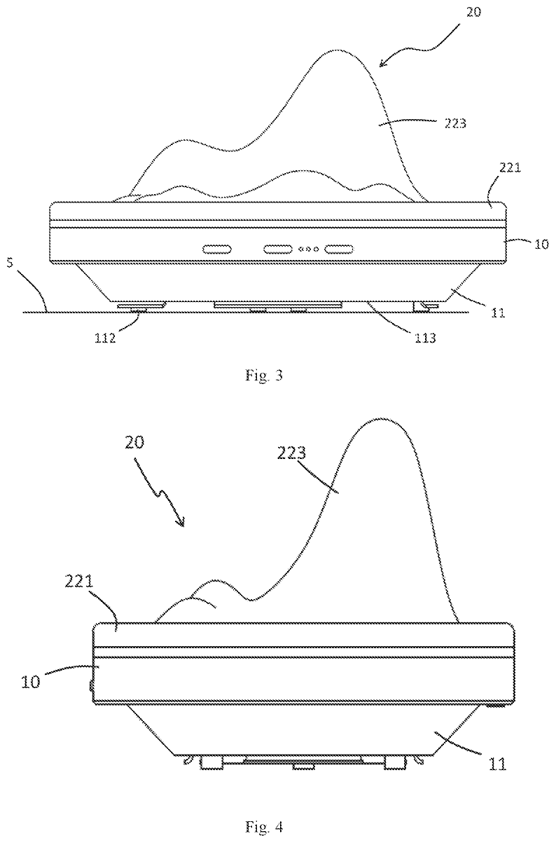

FIGS. 1 to 8 illustrate a first example of a mist maker featuring forced airflow to reduce moisture condensation and/or featuring airflow drifting (hereinafter simply referred to as “mist maker”) according to the disclosure, which, in an example, serves as a mist maker 1 featuring airflow drifting, comprising: a hollow water-proof housing 10 as a pedestal, and a base 20 which covers the hollow water-proof housing 10, has a special shape, and provides a flow space for mist to drift, wherein the hollow water-proof housing 10 and the base 20 constitute a main structure of the mist maker 1 in this example. The hollow water-proof housing 10 comprises a pedestal 11, and a top 12 disposed in the pedestal 11. The pedestal 11 refers to a container having an inwardly recessed space. In this example, the top 12 is disposed across inner side walls of the pedestal 11. The top 12 also has a inwardly recessed structure to form an accommodation space 121 for accommodating liquid, the top 12 and the pedestal 11 being water-tightly fitted with each other such that a water-proof interlayer 111 is formed between the top 12 and the pedestal 11; a control module of the mist maker 1 may be provided in the water-proof interlayer 111 so as to avoid moisture-induced short-circuit or corrosion.

The pedestal 11 of the hollow water-proof housing 10 may be disposed on top of furniture such as a desk or a cabinet. To facilitate illustration, the desk top or cabinet top is defined herein as a worktop 5. The pedestal 11 in this example comprises a plurality of support portions 112 and a raised portion 113 supported by the support portions 112 such that when the pedestal 11 is disposed on the worktop 5, the support portions 112 contact the worktop 5, with an interval being provided between the raised portion 113 and the worktop 5. To those of normal skill in the art, it is easily understood that the pedestal 11 may also have a planar bottom so as to be directly placed on the worktop 5.

The pedestal 11 in this example further comprises a tapered first surrounding wall 114 connected over the raised portion 113, a holding portion 115 extending radially horizontally from the top of the first surrounding wall 114, and a straight second surrounding wall 116 connected to the outer end edge of the holding portion 115; the top 12 comprises a bottom plate 122 and a straight outer peripheral wall 123 connected to the bottom plate 122; the outer peripheral wall 123 and the bottom plate 122 enclose the accommodation space 121, wherein the accommodation space 121 may be configured to accommodate perfumed water or simply accommodate water; moreover, an upward opening is formed at the top end edge of the outer peripheral wall 123.

The profile of the outer peripheral wall 123 of the top 12 agrees with the second surrounding wall 116 of the pedestal 11; therefore, the bottom plate 122 of the top 12 may be held by the holding portion 115 of the pedestal 11, and the outer peripheral wall 123 of the top 12 and the second surrounding wall 116 of the pedestal 11 are tightly fitted to prevent the water solution in the accommodation space 121 from leaking into the water-proof interlayer 111; or, a liquid-tight O-ring may be provided between the outer peripheral wall 123 and the second surrounding wall 116. To facilitate installation of the base 20, the top end of the second surrounding wall 116 is higher than the top end of the outer peripheral wall 123 in this example.

An annular groove 21 is formed at the lower surface of the base 20; the profile of the annular groove 21 agrees with that of the second surrounding wall 116, such that by sleeving the annular groove 21 on the top end of the second surrounding wall 116, the base 20 may be positioned at the pedestal 11 of the hollow water-proof housing 10. A shaped portion 22 is provided on the upper surface of the base 20. The shaped portion 22 comprises a surrounding wall edge 221, a flow zone 222 enclosed by the surrounding wall edge 221, and a miniaturized landscape zone 223 disposed in the flow zone and having one or more tilted faces. The shape of the miniaturized landscape zone 223 may vary dependent on the desired atmosphere to create. For example, the miniaturized landscape may resemble a high-standing mountain, such that the mist drifting around the mountain may enhance concentration and refresh spirits; the miniaturized landscape may resemble a remote and ancient valley, wherein the mist lingers around the valley to promote a deep sleep; and the miniaturized landscape may alternatively resemble a lake with islands, wherein the mist hovers the lake and islands to render a deep relaxation. Of course, to promote market acceptance, a local representative landscape may be selected as the shaped portion.

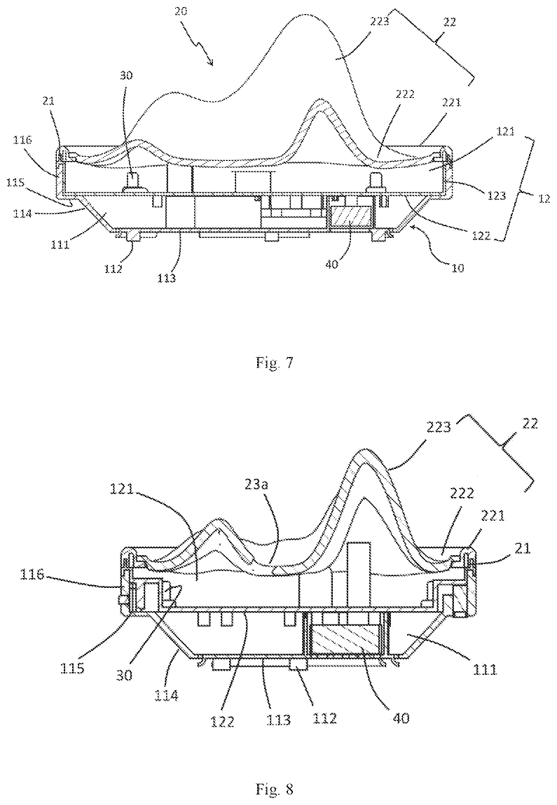

To achieve light weight and save materials, the lower surface of the base 20 may have a profile corresponding to the upper surface. As illustrated in FIG. 7 and FIG. 8, when the base 20 is mounted in the second surrounding wall 116, the space enclosed by the profile of the lower surface of the base 20 may increase the volume of the accommodation space 121. The base 20 further comprises two mist outlet nozzles 23a, 23b. In this example, the mist outlet nozzles 23a, 23b are disposed in the flow zone 222, wherein the mist outlet nozzle 23a faces the miniaturized landscape zone 223, and the mist outlet nozzle 23b faces the surrounding wall edge 221; the axial direction of the mist outlet nozzles 23a, 23b has a tilt angle of less than 90° and greater than 0° relative to the horizontal plane, such that when the mist is pushed out via the mist outlet nozzles 23a, 23b, a horizontal direction airflow component is generated in addition to a vertical direction airflow component, allowing for the high-moisture oversaturated misty airflow to flow within the flow zone 222; moreover, due to confinement by the surrounding wall edge 221, the mist recirculates in the flow zone 222, drifting around the miniaturized landscape zone 223, thereby forming a miniaturized landscape resembling a mist-enveloped landscape and creating a desired atmosphere in the indoor environment. To avoid the mist from easily flowing across the surrounding wall edge 221, the axial direction of the mist outlet nozzle 23b is preferably intersected with the surrounding edge range 221, i.e., the axial direction of the mist outlet nozzle 23b preferably does not exceed the top end of the surrounding wall edge 221, such that the mist, which is blocked by the surrounding wall edge 221 and the tilted miniaturized landscape zone 223, recirculates in the flow zone 222.

Although the base 20 in this example is formed by a water-proof plastic material; those skilled in the art may easily understand that the base 20 may select a material such as a ceramic or acrylic material, and even a water permeable material, which constitutes no limitation to implementation of the disclosure. In this example, the mist outlet nozzles 23a, 23b are circular holes, but the disclosure is not limited thereto. The mist outlet nozzles may be of a slit or any other shape, which may also be disposed at the surrounding wall edge 221. In addition, the mist outlet nozzles may also be disposed at a higher position of the miniaturized landscape zone 223; moreover, the axial direction of the mist outlet nozzles faces an angle lower than the horizontal plane, such that the mist flows towards the flow zone 222, which constitutes no limitation to implementation of the disclosure either.

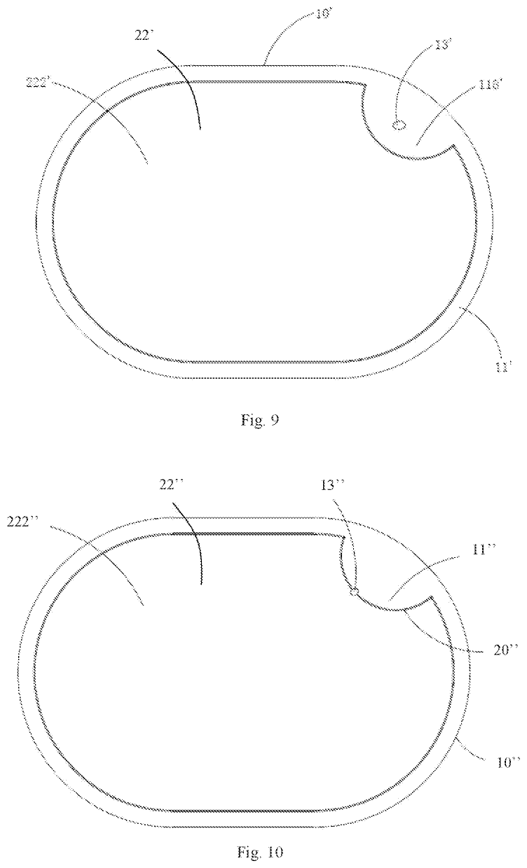

Please refer to FIG. 9, which illustrates another example of a mist maker featuring forced airflow to reduce moisture condensation and/or featuring airflow drifting according to the disclosure. In this example, a boss 118′ protruding toward the horizontal direction is formed at the top end of the pedestal 11′ of the hollow water-proof housing 10′, and the mist outlet nozzle 13′ is provided on the boss 118′ such that the mist in the accommodation space flows out via the mist outlet nozzle 13′ to the flow zone 222′, and the hollow water-proof housing 10′ is formed with a shaped portion 22′.

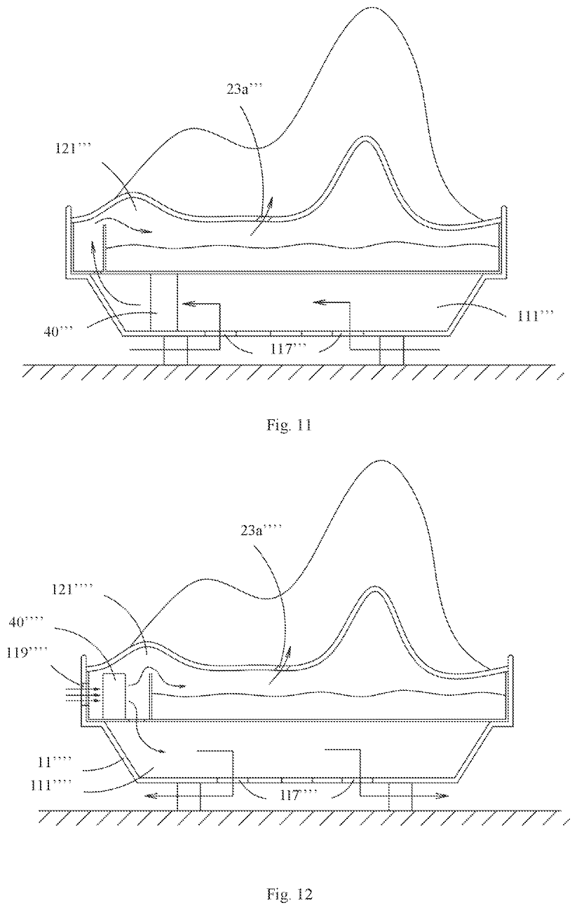

Please refer to FIG. 10, which illustrates an even further example of the mist maker featuring forced airflow to reduce moisture condensation and/or featuring airflow drifting. In this example, the mist outlet nozzle 13″ is disposed between the pedestal 11″ of the hollow water-proof housing 10″ and the base 20″, i.e., the mist outlet nozzle 13″ is formed by fitting between the pedestal 11 of the hollow water-proof housing 10″ and the notch of the base 20″, wherein the mist in the accommodation space flows out via the mist outlet nozzle 13″ to the flow zone 222″, and the hollow water-proof housing 10″ and the base 20″ are formed with a shaped portion 22″.

The mist maker 1 in this example further comprises an atomizer 30 which is disposed in the accommodation space 121 accommodating the essential oil-water solution. The atomizer 30 may be an ultrasonic oscillator, wherein the water solution is atomized into tiny liquid droplets by ultrasonic waves; the atomizer 30 may optionally be a Venturi tube, which accelerates the airflow and facilitates atomization of the essential oil-water solution. The disclosure has no limitation on the atomizer, as long as it can atomize the essential oil-water solution. In addition, considering that while the atomizer 30 is atomizing tiny liquid droplets, the mist might be blocked by the miniaturized landscape zone 223 or other covering above to condense and the condensed water droplets might fall down and flow back into the atomizer 30, which may affect service life of the circuit of the atomizer 30, in this example, a water-proof hood 35 is additionally provided above the atomizer 30 to shelter from the falling condensed water droplets. In this example, the atomizer is disposed at the top 12 of the hollow water-proof housing 10. To those skilled in the art, it is understood that the atomizer may be optionally disposed at the lower surface of the base 20, or a plurality of atomizers are disposed at the top 12 of the hollow water-proof housing 10 and the lower surface of the base 20, respectively.

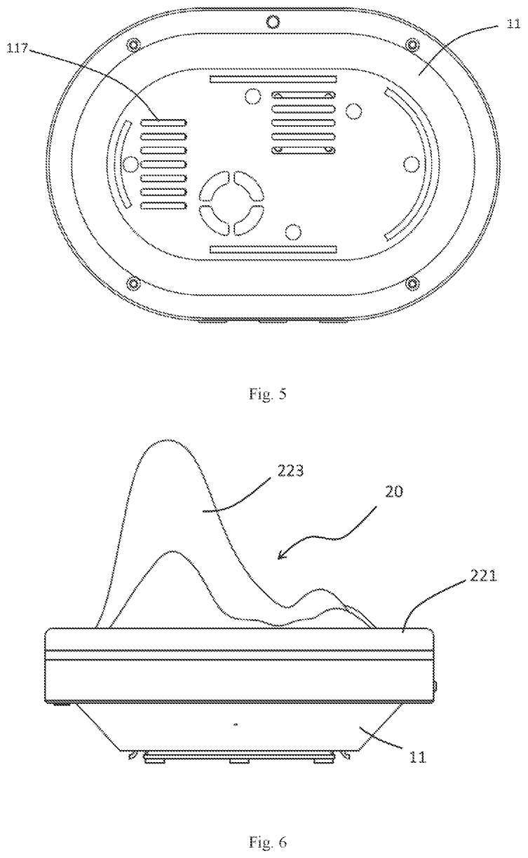

In this example, the mist maker 1 further comprises an air blowing device 40 configured to produce a forced airflow, wherein the air blowing device 40 is disposed in the water-proof interlayer 111 between the pedestal 11 and the top 12 of the hollow water-proof housing 10. The forced airflow produced by the air blowing device 40 enters a mist-enveloped accommodation space 121 via an appropriate flow channel, pushing the mist to flow out via the mist outlet nozzles 23a, 23b and recirculate in the flow zone 222. Additionally, as illustrated in FIG. 5, a plurality of air vents 117 are provided in the raised portion 113 at the bottom of the pedestal 11, wherein the forced airflow produced by the air blowing device 40 is discharged via the air vents 117, and radially flows out along the worktop 5 via the gap between the raised portion 113 and the worktop 5, such that when a fraction of the mist flows out across the surrounding edge wall 221, the forced airflow produced by the air blowing device 40 may carry the mist farther away, preventing the mist from building up around the mist maker 1 and avoiding the moisture in the air around the mist maker 1 from exceeding the saturation humidity, thereby avoiding water accumulation due to mist condensation on the worktop 5. In this example, the air blowing device 40 comprises a fan and a motor. The motor is electrically connected to the control module. The control module controls the rotating speed of the motor to thereby control the flow rate of the forced airflow, such that the mist flows in the flow zone 222 at an appropriate flow rate, creating various visual effects as described above.

In this way, besides enabling the mist to generate a drifting effect in the flow zone 222, the mist maker 1 in this example may also carry the mist farther away via the forced airflow, thereby decreasing the relative humidity in the area around the mist maker 1 and avoiding water accumulation.

To those of normal skill in the art, the base may also be a flat cover, wherein the mist flows out via the mist outlet nozzles, while the forced airflow produced by the air blowing device carriers the mist farther away, thereby lowering the moisture around the mist maker and avoiding water accumulation, i.e., the mist maker only produces a forced airflow to reduce moisture condensation, which does not provide an airflow drifting effect.

To those of normal skill in the art, if the base 20 has the structure illustrated in FIGS. 1 to 8 but no air vents are provided in the pedestal, the forced airflow produced by the air blowing device only pushes the mist out via the mist outlet nozzles 23a, 23b to create a mist drifting effect at the base 20, but does not produce moisture condensation reducing effect.

FIG. 11 illustrates a still another example of the mist maker featuring forced airflow to reduce moisture condensation and/or featuring airflow drifting according to the disclosure. In this example, the air blowing device 40′″ is disposed in the water-proof interlayer 111′″, which draws the external air to the water-proof interlayer 111′″ via air vents 117′″ and into the accommodation space 121′″ via an appropriate flow channel, which brings in the accommodation space 121′″ to flow to the outside again via the mist outlet nozzle 23a′″; in this way, the misty air entering the accommodation space 121′″ from the outside flows to the outside again, thereby generating a flow recirculation. In this way, the mist overflowing out of the flow zone may be drawn back into the accommodation space 121′″ again due to the suction action of the air blowing device 40′″ and then flows out via the mist outlet nozzle 23a′″, which may avoid mist accumulation around the mist maker, preventing the moisture of the air around the mist maker from exceeding the saturation humidity, thereby avoiding water condensation on the worktop to incur water accumulation.

FIG. 12 illustrates an even still another example of the mist maker featuring forced airflow to reduce moisture condensation and/or featuring airflow drifting according to the disclosure. In this example, in addition to air vents 117″″ disposed in the bottom, air vents 119″″ are further provided in the outer peripheral surface of the pedestal 11″″; and the air blowing device 40′″ is disposed in the accommodation space 121″″, wherein the forced airflow produced by the air blowing device 40′″ enters the water-proof interlayer 111″″ via through holes in the top 12″″ and then flows out via the air vents 117″″ in the bottom, and flows back into the accommodation space 121″″ via the air vents 119″″ in the outer peripheral surface of the pedestal 11″″. The forced airflow further flows through the accommodation space 121″″ to push the mist out via the mist outlet nozzle 23a″″. In this way, the mist overflowing out of the flow zone may be drawn back into the accommodation space 121″″ due to the suction action of the air blowing device 40″″, which further enters the flow zone again or is discharged to the outside, thereby forming a flow recirculation. This may also prevent the mist from building up around the mist maker and causing water accumulation due to oversaturated humidity.

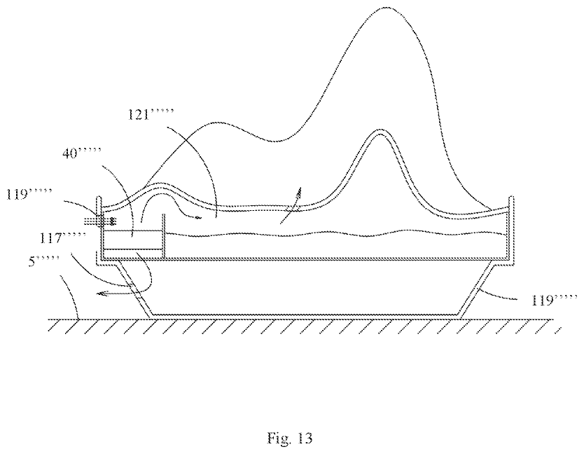

FIG. 13 illustrates a still yet another example of the mist maker featuring forced airflow to reduce moisture condensation and/or featuring airflow drifting according to the disclosure. In this embodiment, the pedestal 11′″″ has a planar bottom and thus can be directly placed on the worktop 5′″″. Therefore, the air vents 117′″″ for air discharge purposes and the air vents 119′″″ for drawing purposes may be both provided in the outer peripheral surface of the pedestal 11′″″. In this example, the air blowing device 40′″″ is disposed in the accommodation space 121′″″.

In the mist maker featuring forced airflow to reduce moisture condensation as disclosed, the forced airflow produced by the air blowing device flows radially above the worktop but lower than the surrounding wall edge, allowing for the mist to flow towards all directions farther away from the mist maker, such that the mist may be absorbed by the distant air which has not built up to the saturation humidity, thereby avoiding the mist, which cannot be absorbed by the oversaturated air around the mist maker, from condensing on the desktop or the ground. In addition, since the mist from the mist maker featuring forced airflow to reduce moisture condensation according to the disclosure does not condense on the desktop or the ground, but may remain in the misty state or be adsorbed by air, the mist has a relatively large contact area with the air, such that the essential oil ingredient in the mist may be extensively and quickly volatized to the air and dispersed to the entire indoor environment, rapidly rendering a preset aromatic smell to the user. Conventional humidifiers do not have an air blowing device, such that even in a relatively dry environment, the mist flowing out of such humidifiers is still built up around the humidifier, causing water accumulation. The mist maker featuring forced airflow to reduce moisture condensation according to the disclosure leverages the forced airflow to carry the mist radially away from the humidifier or draw the mist back to the humidifier in all directions, thereby avoiding water accumulation arising from the oversaturated air around the humidifier.

Furthermore, by allowing the mist to drift in the flow zone confined by the mist maker structure and in conjunction with a special profile of the mist maker, the mist maker featuring airflow drifting according to the disclosure may create a special visual effect and provide the user a desired relaxing and pleasant atmosphere. Additionally, the mist maker according to the disclosure features both forced airflow to reduce moisture condensation and mist drifting, such that even the indoor environment is somewhat damp, when the mist maker is producing an aromatic mist, not only a mist drifting visual effect is created, water accumulation can also be avoided thanks to the forced airflow. Therefore, besides the capability of atomizing perfumed water and diffusing the essential oil carried by mist droplets to the indoor environment like conventional technologies, the mist maker featuring forced airflow to reduce moisture condensation and/or featuring airflow drifting according to the disclosure further resolves the drawbacks of conventional mist makers such as monotonous mist pattern and proneness to water accumulation on a desktop or the ground.

What have been described above are only embodiments of the disclosure, which cannot be construed as limitations to the scope of the disclosure. Any simple equivalent variations and modifications made based on the contents in the appended claims and specification shall fall within the scope of the disclosure. Through the description in the embodiments of the disclosure, those skilled in the art may understand that the disclosure is novel, represents progress, and has industrial practicality and thus has a value for development.

I/We claim:

1. A mist maker, comprising:
a hollow water-proof housing formed with an accommodation space, the hollow water-proof housing having a pedestal that is configured to dispose the mist maker on a worktop, and an opening being provided on top of the accommodation space, wherein the accommodation space is configured to accommodate liquid;
a base configured to at least partially cover the opening, wherein the hollow water-proof housing and/or the base are formed with a shaped portion whose projection direction corresponds to the opening, and the shaped portion comprises a surrounding wall edge and a flow zone enclosed by the surrounding wall edge,
wherein the hollow water-proof housing and/or the base are formed with at least one mist outlet nozzle corresponding to the flow zone;
an atomizer disposed in the hollow water-proof housing and/or the base, configured to atomize the liquid accommodated in the accommodation space and push the atomized liquid out via the mist outlet nozzle; and
an air blowing device disposed at the hollow water-proof housing and/or the base, configured to produce a forced airflow, the forced airflow flowing radially above the worktop but lower than the surrounding wall edge, whereby to lower moisture in the air above the worktop around the hollow water-proof housing.

2. The mist maker of claim 1, wherein the hollow water-proof housing further comprises a top, the top and the pedestal jointly forming a water-proof interlayer.

3. The mist maker of claim 2, wherein the top is provided with a recessed structure serving as the accommodation space.

4. The mist maker of claim 2, wherein the pedestal is provided with a plurality of air vents, and the air blowing device communicates with the water-proof interlayer, such that when the air blowing device is actuated, the forced airflow is discharged/drawn via the air vents.

5. The mist maker of claim 1, wherein the pedestal comprises a plurality of support portions and a raised portion supported by the support portions, wherein an interval is provided between the raised portion and the worktop.

6. The mist maker of claim 1, wherein a bottom of the pedestal is a flat plane abutting against the worktop.

7. The mist maker of claim 1, wherein a plurality of through holes are provided in the pedestal, and the forced airflow produced by the air blowing device is discharged via the through holes and flows along a direction away from the pedestal.

8. A mist maker, comprising:
a hollow water-proof housing formed with an accommodation space, the hollow water-proof housing having a pedestal that is configured to dispose the mist maker on a worktop, an opening being formed on top of the accommodation space, wherein the accommodation space is configured to accommodate liquid;
a base configured to at least partially cover the opening, wherein the hollow water-proof housing and/or the base are provided with a shaped portion whose projection direction corresponds to the opening, and the shaped portion comprises a surrounding wall edge, a flow zone enclosed by the surrounding wall edge, and a miniaturized landscape zone having at least one tilted face;
wherein the hollow water-proof housing and/or the base are formed with at least one mist outlet nozzle corresponding to the flow zone; wherein the mist outlet nozzle is tilted, and the at least one tilted mist outlet zone faces the miniaturized landscape zone;
an atomizer disposed in the hollow water-proof housing and/or the base, configured to atomize the liquid accommodated in the accommodation space and push the atomized liquid out via the mist outlet nozzle; and
an air blowing device disposed at the hollow water-proof housing and/or the base, configured to produce a forced airflow.

9. The mist maker of claim 8, wherein a plurality of mist outlet nozzles are provided in the hollow water-proof housing and/or the base, at least one of the mist outlet nozzles facing the surrounding wall edge.

10. The mist maker of claim 8, wherein the mist outlet nozzle extends axially to intersect with the surrounding wall edge.
